(19) United States
(12) Patent Application Publication
(10) Pub. No.: US 2010/0225151 A1
(43) Pub. Date: Sep. 9, 2010

(54) VEHICLE SEAT ACTUATION MECHANISM

(75) Inventors: Eric B. Michalak, Northville, MI (US); Gregg Ronald Laframboise, Windsor (CA); Kurt A. Seibold, Whitmore Lake, MI (US)

Correspondence Address: BUTZEL LONG;IP DOCKETING DEPT, 350 SOUTH MAIN STREET, SUITE 300, ANN ARBOR, MI, 48104, US

(73) Assignee: Johnson Controls Technology Company, Holland, MI (US)

(21) Appl. No.: 12/716,708

(22) Filed: Mar. 3, 2010

Related U.S. Application Data
(60) Provisional application No. 61/157,481, filed on Mar. 4, 2009.
(60) Provisional application No. 61/256,175, filed on Oct. 29, 2009.

(51) Int. Cl. B60N 2/02; B60N 2/30; B60N 2/20; B60N 2/22; B60N 2/06

(52) U.S. Cl. 297/344.1

(57) ABSTRACT

A seat for use in a vehicle having a seat back pivotably coupled to a seat base by a recliner mechanism such that the seat back can be pivoted in a forward and rearward direction relative the seat base. The seat also includes a track assembly coupled to the vehicle and the seat, such that the seat can be moved in the forward and rearward directions relative to the vehicle interior. The seat also includes an actuator mechanism having a first actuator, a second actuator, and an energy storage device for storing energy generated from movement of the seat and selectively releasing the stored energy to assist in repositioning the seat when at least one of the first actuator and second actuator is actuated. Actuating the first actuator causes the seat to move from a first position to a second position, and actuating the second actuator causes the seat to move from a first position to a third position.

### CROSS-REFERENCE TO RELATED APPLICATIONS

This application claims the benefit of and priority to U.S. Provisional Patent Application No. 61/157,481, filed Mar. 4, 2009, titled: VEHICLE SEAT ACTUATION MECHANISM, in the name of Laframboise et al. and U.S. Provisional Patent Application No. 61/256,175, filed Oct. 29, 2009, titled: ENERGY DEVICE BYPASS MECHANISM, in the name of Seibold et al. which are incorporated by reference herein.

### BACKGROUND

The present disclosure relates generally to improvements to a vehicle seat. More particularly the present disclosure relates to improvements relating to a vehicle seat having an actuation mechanism for adjusting the vehicle seat and a recliner energy device bypass mechanism.

It is generally known to provide adjustable vehicle seats. Further, it is generally known to provide an adjustable track assembly for adjusting the fore-aft position of the vehicle seat within the vehicle. Such a track assembly is known for use in providing fore-aft adjustment to vehicle seats such a “captain's chair” or other type of vehicle seats. The linear adjustable vehicle seat allows an occupant to obtain a more comfortable seating position and to provide space behind or in front of the vehicle seat. Generally, actuation mechanisms are known for actuating the recliner mechanism so that the seat may be adjusted in the fore-aft direction along the seat track and/or so the seat back may be adjusted in the fore-aft direction. Such actuation mechanisms are generally known as levers or handles.

It is also generally known to use a recliner mechanism in a vehicle seat to allow a seat occupant to adjust the position of the seat back with respect to the seat base. Such known recliner mechanisms may typically be actuated by the seat occupant to selectively adjust the angular position of the seat back with respect to the seat base. Various vehicle seats have been developed with seat back adjusting or reclining mechanisms that provide for the reclining angle of the seat back to be adjusted, that provide for rotation of the seat back to a forward position, including a dump position, for easy entry (EZ entry) to the area of the vehicle behind the vehicle seat. Such reclining mechanisms may also provide for rotation of the seat back to a stow flat position over the seat bottom for storage of the seat within the vehicle or for storage of the seat when removed from the vehicle. Known vehicle seats also can include a stored energy and release control device for facilitating reconfiguration of the vehicle seat with reduced input force by a user. However, when such known energy storage devices are activated, whether intentionally or unintentionally, the recliner mechanism can be released, whether the seat is occupied or unoccupied, and must be cycled back to a fully dumped (EZ entry/folded) position and then returned back to a design (use) position to re-engage the recliner thereby creating a number of issues, such as safety issues. Various embodiments of such energy storage devices are set forth in the following United States Patent Application, which is incorporated herein by reference: U.S. Pat. App. No. 2008/0067851, filed Aug. 22, 2007, Tomandl.

Thus there remains a continuing need to provide improved seats, including in particular vehicle seats that are easier to operate and/or adjust and require less effort and force to operate and/or adjust. There also remains a continuing need to provide an energy storage and release control system that facilitates ingress and egress into the vehicle, enhances safety, and is also relatively simple in design.

### SUMMARY

A seat for use in a vehicle having a seat back pivotably coupled to a seat base by a recliner mechanism such that the seat back can be pivoted in a forward and rearward direction relative the seat base. The seat also includes a track assembly coupled to the vehicle and the seat, such that the seat can be moved in the forward and rearward directions relative to the vehicle interior. The seat also includes an actuator mechanism having a first actuator, a second actuator, and an energy storage device for storing energy generated from movement of the seat and selectively releasing the stored energy to assist in repositioning the seat when at least one of the first actuator and second actuator is actuated. Actuating the first actuator causes the seat to move from a first position to a second position, and actuating the second actuator causes the seat to move from a first position to a third position.

A seat for use in a vehicle having a seat back pivotably coupled to a seat base by a recliner mechanism such that the seat back can be pivoted in a forward and rearward direction relative the seat base. The seat also includes a track assembly coupled to the vehicle and the seat, such that the seat can be moved in the forward and rearward directions relative to the vehicle interior. The seat also includes an actuator mechanism having a first actuator, a second actuator, and an energy storage device for storing energy generated from movement of the seat and selectively releasing the stored energy to assist in repositioning the seat when at least one of the first actuator and second actuator is actuated. Actuating the first actuator causes the seat to move from a first position to a second position, and actuating the second actuator causes the seat to move from a first position to a third position. The seat can also include an energy bypass mechanism that prevents the release of stored energy in the energy storage device when the seat is occupied and enables the release of stored energy in the energy device when the seat is not occupied.

### BRIEF DESCRIPTION OF THE DRAWINGS

FIG. 1 is a perspective view of a vehicle including a vehicle seat according to an exemplary embodiment.

FIG. 2 is a perspective view of a vehicle seat of the vehicle of FIG. 1 according to an exemplary embodiment.

FIG. 3 is a side view of a vehicle seat according to an exemplary embodiment.

FIG. 4 is a side view of the vehicle seat of FIG. 2 in an easy entry position, according to an exemplary embodiment.

FIG. 5 is a side view of the vehicle seat of FIG. 2 in a fold flat position, according to an exemplary embodiment.

FIG. 6 is a side view of the vehicle seat having a push button actuation mechanism for actuating the vehicle seat, according to an exemplary embodiment.

FIG. 7 is a partial enlarged view of the first push button actuator of the vehicle seat of FIG. 6, according to an exemplary embodiment.

FIG. 8 is a side view of the vehicle seat of FIG. 6 articulated from a design position to an easy entry position, according to an exemplary embodiment.

FIG. 9 is a partial enlarged view of the second push button actuator of the vehicle seat of FIG. 6, according to an exemplary embodiment.

FIG. 10 is a partial enlarged top view of the seat base of the vehicle seat of FIG. 6 including a power actuator, according to an exemplary embodiment.

FIG. 11 is a rear underside view of the seat base of the vehicle seat of FIG. 6 including a torque converter and energy storage device, according to an exemplary embodiment.

FIG. 12 is a side view of an energy storage bypass mechanism, according to an exemplary embodiment.

FIG. 13 is a perspective of seat assembly having an energy storage bypass mechanism, according to an exemplary embodiment.

FIGS. 14A-14C are a series of side views of the energy storage bypass mechanism in an initial mode, an activated mode with the seat unoccupied, and an activated mode with the seat occupied, according to an exemplary embodiment.

FIGS. 15A-15D are a progression of side views of the energy storage bypass mechanism and corresponding seat configuration transitioned between a design position and a reclined position and back to a design position, according to an exemplary embodiment.

FIGS. 16A-16B are side views of an occupied seat and of the energy storage bypass mechanism transitioned from a non-activated mode to an activated mode, according to an exemplary embodiment.

FIG. 17 is a diagram of a seat occupant detection system, according to an exemplary embodiment.

FIG. 18 is a diagram of a seat occupant detection system, according to an alternate embodiment.

FIGS. 19A-19B are diagrams of a seat occupant detection system, according to an alternate embodiment.

FIG. 20 is a diagram of a seat occupant detection system, according to an alternate embodiment.

FIG. 21 is a diagram of a seat occupant detection system, according to an alternate embodiment.

### DETAILED DESCRIPTION

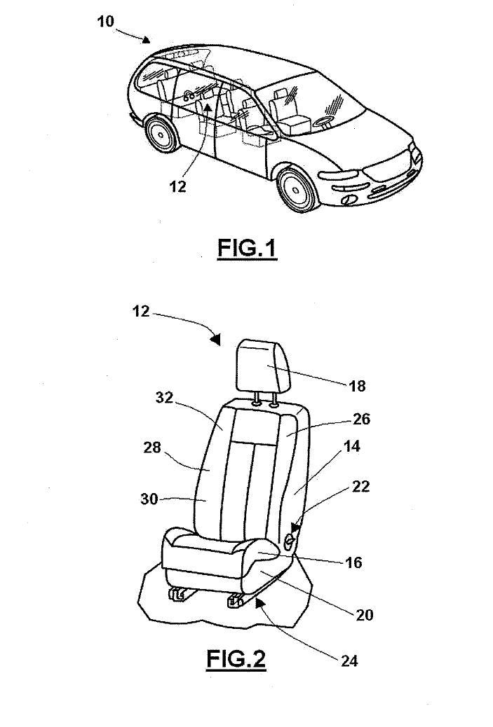

Referring generally to the figures and in particular to FIG. 1, a vehicle 10 is shown according an exemplary embodiment. The vehicle 10 includes one or more vehicle seats 12 provided for occupants of the vehicle 10. While the vehicle 10 shown is a 4-door sedan, it should be understood that the vehicle seat 12 may be used in a mini-van, sport utility, cross-over or any other type of vehicle or any other means in or by which someone travels or something is carried or conveyed for any market or application including everything from office seating and transportation to planes and space travel and everything in between. The vehicle seat 12 shown includes a seat back 14 and a seat cushion 16.

One exemplary embodiment of an upholstered seat structure (e.g., second row seat, third row seat, etc.) 12 is shown in FIG. 2. The vehicle seat 12 can also, and typically does, include a head restraint 18 and a seat base portion 20 for supporting the seat cushion 16. Generally, the head restraint 18 extends upward from the seat back 14 and is configured to restrain the head of an occupant during an impact. The seat back 14 can be pivotably coupled to the seat base 20 and the seat assembly 12 can also include a recliner mechanism 22 for selectively adjusting the seat back 14 relative to the seat base 20. The seat cushion 16 and/or base portion 20 may be configured to allow the seat 12 to be selectively adjusted and positioned (manually or motor driven) relative to the vehicle interior (e.g., via a track assembly 24, etc.). The seat back 14 can also include a first (inboard) and a second (outboard) side bolster 26, 28. The seat assembly 12 can also include a plurality of cushions 30 (e.g., foam, padding, etc.) and a seat/trim cover 32 (e.g., upholstery, leather, fabric, etc.).

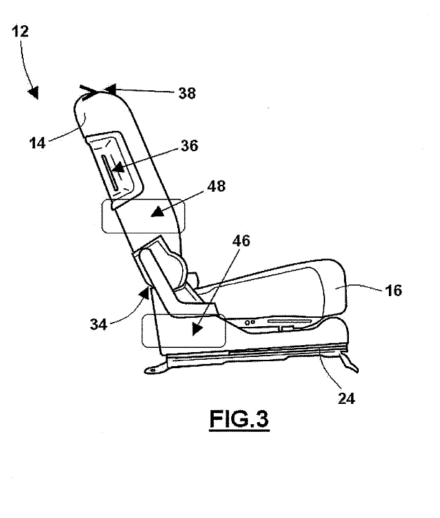

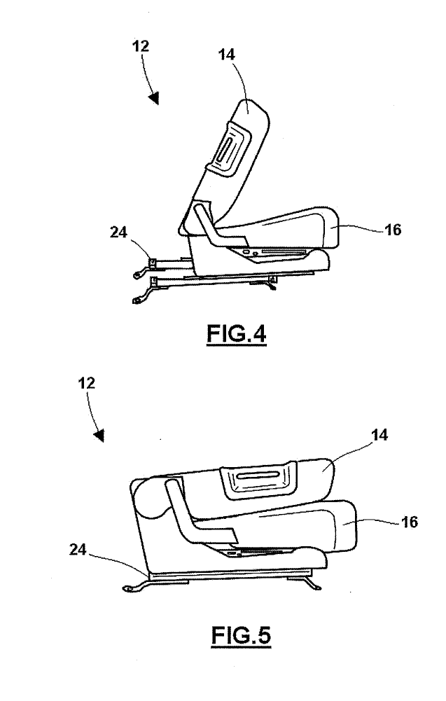

Referring now to FIGS. 3-5, a vehicle seat 12 according to an exemplary embodiment is shown. The vehicle seat 12 includes an actuation mechanism 34 having a first and second seat actuator 36, 38 that are used to actuate (e.g., articulate, adjust, move, fold, etc.) the vehicle seat 12 and come in the form of a handle or lever. The first actuator (handle A) 36 operates to actuate the seat 12 such that the seat back 14 is moved forward (tipped) and the entire seat 12 is moved (slid) forward on the seat track assembly 24 that is coupled to the vehicle 10 (e.g., vehicle floor, etc.), as shown in FIG. 4. This reconfigures the seat 12 from a use (design) position at 40 to an easy entry position at 42 that facilitates vehicle 10 ingress and egress and enhances interior cargo space. The second actuator (handle B) 38 operates to actuate the seat 12 such the seat back 14 is folded forward such that the seat back 14 rests substantially flat on the top surface of the seat cushion 16, as shown in FIG. 5. This places the seat 12 in a fold-flat position at 44 that facilitates vehicle 10 ingress and egress and further enhances interior cargo space. The first and second handles 36, 38 can also be located elsewhere on the seat back 14, seat base 16, or the like.

According to an alternate embodiment, the handles that are used for the first and second actuators (handle A and handle B) 46, 48 may be replaced with push buttons. The first push button actuator (primary button) 46 is preferably located on either the inboard or outboard side of the seat base 16 and towards the rear portion of the seat base 16 (primary button location), as shown in FIG. 3. The second push button actuator (secondary button) 48 is preferably located on either the inboard or outboard side of the seat back 14 and towards the lower end of the sat back 14 (secondary button location), as shown in FIG.3. The first and second push buttons 46, 48 can also be located elsewhere on the seat back 14, seat base 16, or the like. Although the seat 12 shown is a second row seat, any suitable seat may be used (e.g., first row seat, passenger seat, driver's seat, bench seat, etc.).

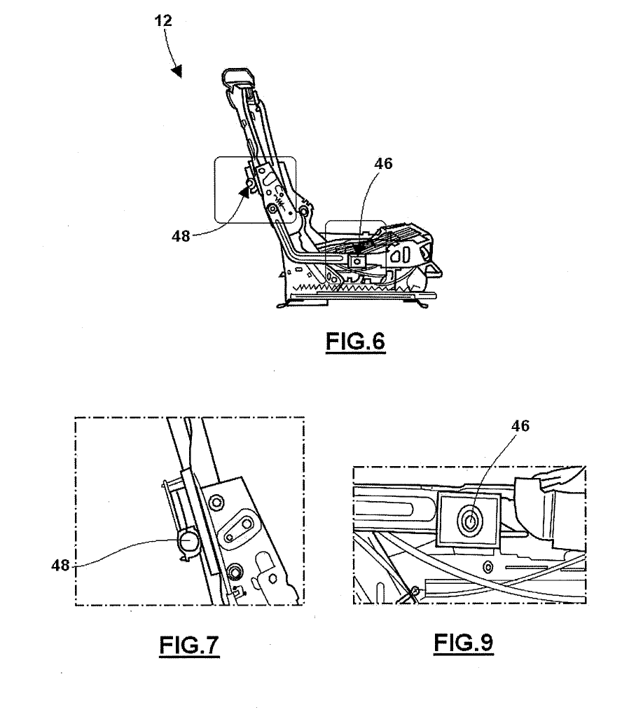

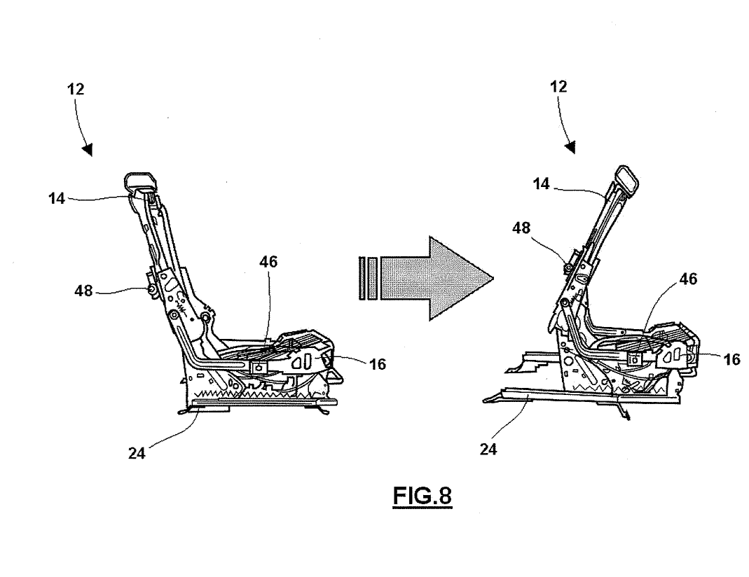

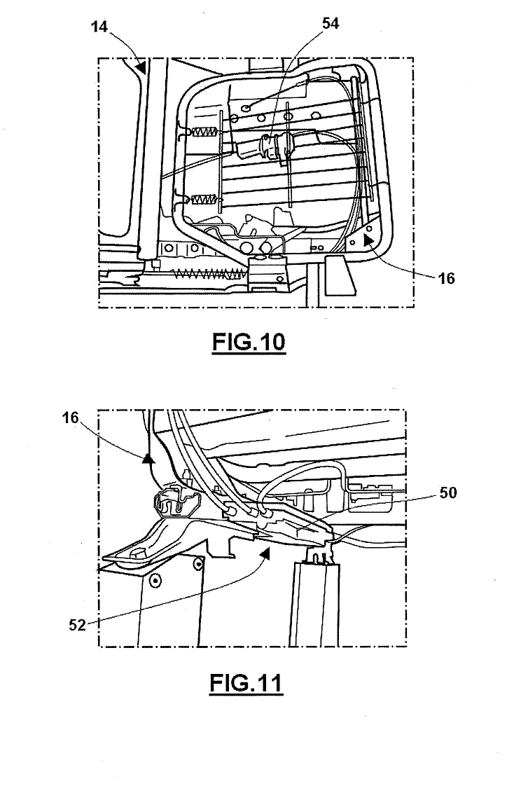

Referring now to FIGS. 6-11, a vehicle seat 12 having a push button actuator mechanism 34 for operating (e.g., articulating, adjusting, moving, folding, sliding, etc.) the vehicle seat, according to an exemplary embodiment. The push button actuator mechanism 34 may be utilized to assist in adjusting (e.g., folding, repositioning, etc.) the vehicle seat 12 to and from various positions (e.g., a first position to a second position; use position, design position, easy-entry position, fold flat position, etc.). For example, if the mechanism 34 is utilized to assist in movement of a vehicle seat 12 to a folded position, the mechanism stores energy as the seat 12 is folded upwardly to a use position, and releases the energy to assist in moving the seat 12 from a use position to a folded position. The push button actuation mechanism 34 includes a first and second actuator (push buttons) 46, 48, a torque converter 50, an energy storage device 52, and a power actuator 54. The push button actuator mechanism 34 may be electronically (e.g., electric switch) or mechanically activated (e.g., manual push button). According to one exemplary embodiment, the first actuator 46 may be a manual push button located on the inboard or outboard side of the seat back 14, as shown in FIGS. 6 and 7. Actuating the first actuator 46 causes the seat back 14 to move (e.g., tilt, pivot, rotate, etc.) forward and the seat 12 to move (e.g., slide, etc.) forward along the track assembly 24 from a use (design) position to an easy entry position that facilitates vehicle 10 ingress and egress, as shown in FIG. 8. According to one exemplary embodiment, the second actuator 48 may be an electrical switch located on the inboard or outboard side of the seat cushion 16, as shown in FIGS. 6 and 9. Actuating the second actuator 48 causes the seat back 14 to move (e.g., tilt, pivot, rotate, etc.) forward and rest substantially flat on the top surface of the seat cushion 16 from a design position to a fold flat position that facilitates vehicle 10 ingress and egress and/or enhances vehicle 10 cargo space. The energy storage device 52, power actuator 54, and torque converter 50 may be located under the seat cushion 16 may be located to either the inboard or outboard side of the seat 12, as shown in FIGS. 10 and 11. The energy storage device 52, power actuator 54, and torque converter (logic box) 50 provide for a mechanism 34 that easily actuates the seat 12 with reduced efforts by utilizing the energy stored in the storage device 52. The manual or electrical switches can be actuated in any combination and may be used for any suitable application (e.g., first row seats, bench seats, driver's seat, passenger seat, etc.) and may be used to adjust the seat 12 to and from any seating position (e.g., design, use, easy entry, fold flat, fold and tumble, etc.). According to one exemplary embodiment, the push button mechanism 34 (or the first actuator, or the second actuator, etc.) may be remotely activated (e.g., using a keyfob, etc.).

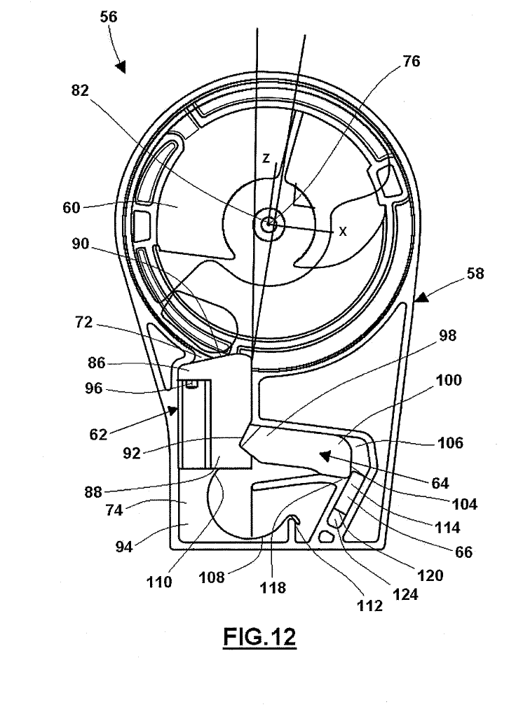

Referring now to FIG. 12, an energy storage bypass mechanism 56 for use in a vehicle seat 12 is shown. The energy storage bypass mechanism 56 includes, among other components, a housing 58, a rotator (pivot) member 60, a slide block (rack) member 62, a pinion member 64, an interlock member 66, biasing members 68; cable members 70, and one or more recliner activation devices 72. The energy storage bypass mechanism 56 can be coupled to the vehicle seat 12 (e.g., seat back, seat base, etc.) and be positioned in any suitable location (e.g., within the seat, under the seat, against the seat, outboard side, inboard side, etc.).

The housing 58 includes an inner area or space 72 having a plurality of contoured extension members (sides, walls, embossments, channels, grooves, ridges, etc.) 74 for housing/enclosing, supporting and guiding the inner components of the energy storage bypass mechanism 56 (e.g., rotator (pivot) member, slide block member, pinion member, interlock member, biasing member, etc.) and a central aperture 76. The housing 58 can also include a plurality of attachment members or brackets 78, and/or fasteners 80 for coupling to other structures (e.g., energy storage bypass mechanism components, vehicle seat structures, etc.). The housing 58 can be made of any suitable material, such as plastic, metal, or the like.

The rotator/pivot member 60 is substantially circular in shape and includes a central aperture 82 for rotatable coupling to the housing 58 (central aperture 76) and vehicle seat 12. It is contemplated, however, that the rotator/pivot member 60 may have other suitable shapes and also be designed to operate/function in a different manner (e.g., linearly, as a cam, rotating stop feature, etc.). The rotator/pivot member 60 is preloaded with a biasing member (e.g., spring, etc.) that acts as an energy storage mechanism and that biases the rotator/pivot member 60 in a predetermined direction (e.g., clock-wise, counter-clockwise, etc.) to facilitate reconfiguration of the vehicle seat 12 with minimal effort when the slide block (rack) member 62 is disengaged from the rotator/pivot member 60.

The slide block (rack) member 62 includes a first end 86 and a second end 88. The first end 86 has an inclined surface 90 (edge, profile, etc.) for engaging the rotator member 60. The second end 88 includes an attachment area 92 for attachment to the pinion member 64 (via the attachment member or clip). The slide block (rack) member 62 is positioned within a first channel 94 in the housing 58 such that the slide block 62 can move (slide, toggle, etc.) in a first and second direction (e.g., upward and downward, etc.) when activated by the pinion member 64. The slide block (rack) member 62 also includes a biasing member 96 (e.g., spring, F-Spring, etc.) that biases the slide block (rack) member 62 in an upward direction to maintain the slide block (rack) member 62 in engagement with the rotator/pivot member 60.

The pinion member 64 is a substantially elongated member having a first end 98 and a second end 100. The first end 98 includes a biasing member 102 (clip) for coupling to the slide block (rack) member 62. The second end 100 includes a surface (edge, profile) 104 for engagement with the interlock member 66. The pinion member 64 is positioned within the housing 58 in a channel 106 substantially perpendicular to the slide block (rack) member channel 94 such that the pinion member 64 can move (slide or toggle) in a first and second direction (e.g., fore and aft, forward and rearward, etc.) when disengaged from the interlock member 66. The pinion member 64 also includes a biasing member 108 having a first end 110 and a second end 112. The first end 110 is coupled to the pinion member 64 (attachment member or clip). The second end 112 is coupled to the housing 58. The biasing member 108 creates a biasing force on the pinion member 64 in an upward and left direction.

The interlock member 66 is a substantially elongated member having a first end 114 and a second end 116. The first end 114 includes a surface (edge, profile, etc.) 118 for engagement with the pinion member 64. The second end 116 includes a surface 120 for attachment to a biasing member (e.g., spring, etc.) 122 that biases the pinion member 64 away from the slide block (rack) member 62. The interlock member 66 is positioned within the housing 58 in a third channel 124 substantially perpendicular to the pinion member channel 106 such that the interlock member 64 can move (slide or toggle) in a first and second direction (e.g., upward and downward, etc.) when activated. When the vehicle seat 12 is unoccupied, the interlock member 66 is in engagement with the pinion member 64 thereby enabling the pinion member 64 to be in engagement with the slide block (rack) member 62 thereby enabling the energy storage bypass mechanism 56 to be released if activated. Conversely, when the vehicle seat 12 is occupied, the interlock member 66 is disengaged from the pinion member 64 and the pinion member 64 is disengaged from the slide block (rack) member 62 thereby preventing the slide block (rack) member 62 from being disengaged from the rotator/pivot member 60 and hence preventing the energy storage mechanism 56 from being released if activated. This feature acts as a safety lockout which renders the energy storage mechanism 56 ineffective if activated.

The recliner activation device 126 activates the energy storage mechanism 128 thereby enabling the vehicle seat 12 to be reconfigured from a design (use) position to a dump position (easy (EZ) entry) for facilitating ingress and egress from the vehicle 10. The recliner energy storage mechanism 128 can have one or more handles, levers, buttons, switches, and/or the like to activate the recliner energy mechanism 128. One or more recliner activation devices 130 can be implemented and the recliner activation devices 130 can be coupled in a variety locations on the vehicle seat 12 (e.g., seat back, seat base, rear surface of the seat back, outboard or inboard side of the seat base, etc.) that are conveniently and easily accessed by the vehicle 10 occupants.

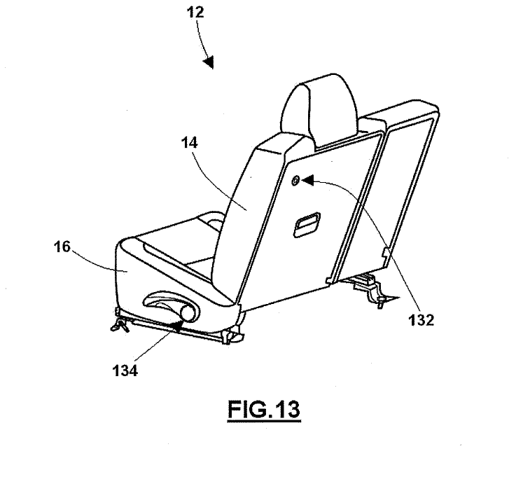

Referring now to FIG. 13, a vehicle seat assembly 12 is shown having the energy storage bypass mechanism 56 of the present disclosure is shown. According to one exemplary embodiment, the vehicle seat assembly 12 includes a first recliner activation device (e.g., button, lever, handle, etc.) 132 mounted on the rear surface of the seat back 14 that can be accessed by vehicle occupants (e.g., occupants in the third row of the vehicle, etc.), and a second recliner activation device (e.g. button integrated with the seat back recliner lever, etc.) 134 mounted on the side (e.g., outboard side) of the seat base 16 that can be accessed from outside the vehicle 10.

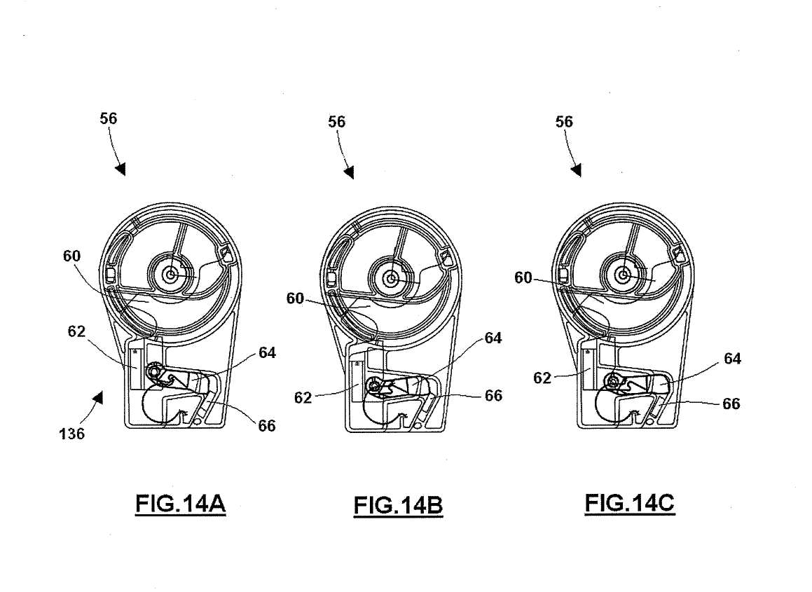

Referring now to FIGS. 14A-14C, a series of side views of the energy storage bypass mechanism 56 in various modes are shown. In the initial mode at 136, the interlock member 66 is in engagement with the pinion member 64 which maintains the slide block member 62 in engagement with the rotator/pivot member 60 thereby maintaining the energy storage mechanism 56 in engagement (latched, locked, etc.). When the vehicle seat 12 is unoccupied and the recliner activation device 130 (e.g., button) is activated, the interlock member 66 remains in engagement with the pinion member 64 and causes the slide block (rack) member 62 to disengage from the rotator/pivot member 60 thereby disengaging the energy storage bypass mechanism 56 thereby enabling the stored energy in the energy storage mechanism 128 (via the rotator/pivot member) to be released and thereby enabling the vehicle seat 12 to be reconfigured. When the vehicle seat 12 is occupied and the recliner activation device 130 (e.g., button) is activated, the interlock member 66 is disengaged from the interlock member 66 thereby preventing the stored energy in the energy storage mechanism 128 from being released thereby preventing safety issues when the energy storage mechanism 128 is released while the vehicle seat 12 is occupied.

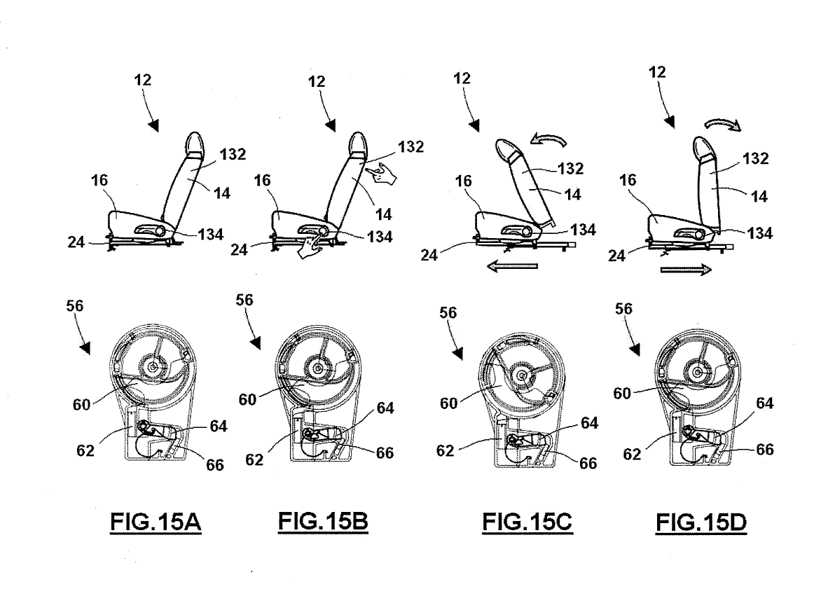

Referring now to FIGS. 15A-15D, a progression of side views of the energy storage bypass mechanism 56 and corresponding seat configuration transitioned between a design position and a reclined position and back to a design position are shown. When the recliner activation device 130 (e.g. button) is activated, the slide block member 62 is pulled downward out of engagement with the rotator/pivot member 60 via the pinion member 64 thereby disengaging the energy storage bypass mechanism 56 (releasing the stored energy in the rotator/pivot member biasing member) enabling the vehicle seat 12 to be reconfigured into an EZ entry position (e.g., seat back rotates forward, vehicle seat moves/slides in the forward direction, etc.) with minimal effort to facilitate ingress into and/or egress from the vehicle 10. The biasing member 84 (e.g., spring) is preloaded such that when the vehicle seat 12 is moved back into the design position the energy storage bypass mechanism 56 reengages (resets) and is ready to be activated once again.

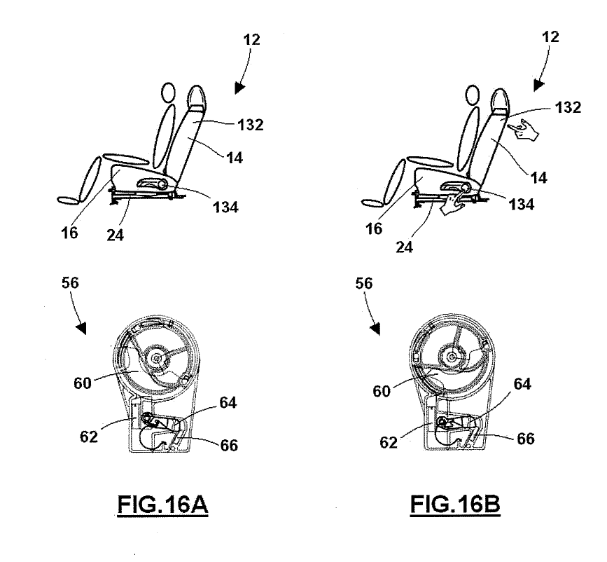

Referring now to FIGS. 16A-16B, two side views of an occupied seat 12 and of the energy storage bypass mechanism 56 transitioned from a non-activated to an activated mode are shown. When the seat 12 is occupied the interlock member 66 is pulled downward and is disengaged from the pinion member 64. Thus, when the recliner activation device 130 (e.g., button) is activated, the pinion member 64 moves (slides) over away from the slide block (rack) member 62 instead of pulling on the slide block (rack) member 62 thereby disengaging the energy storage bypass mechanism 56. Although this is one way of stopping forces transferring from cable input to slide block member (rack) 62, other techniques can be employed, such as a stop feature in the cable where it can slide in the housing 58 when the stop is removed.

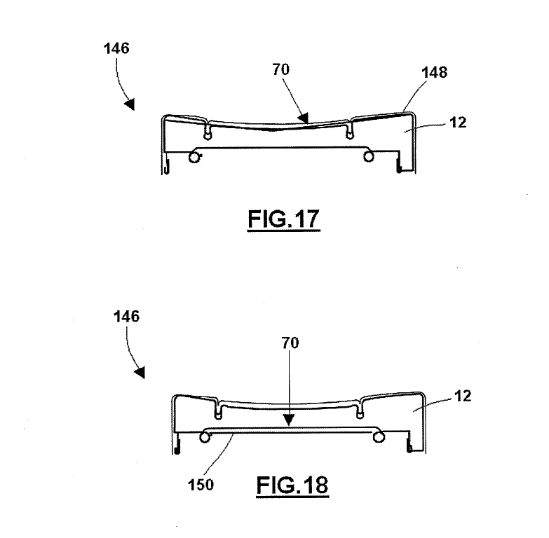

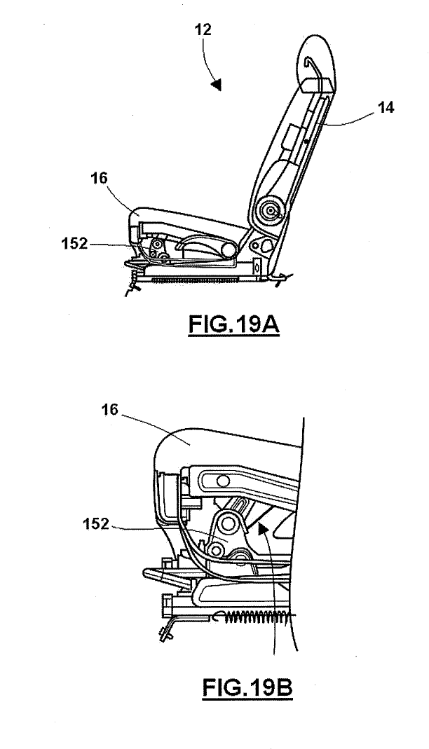

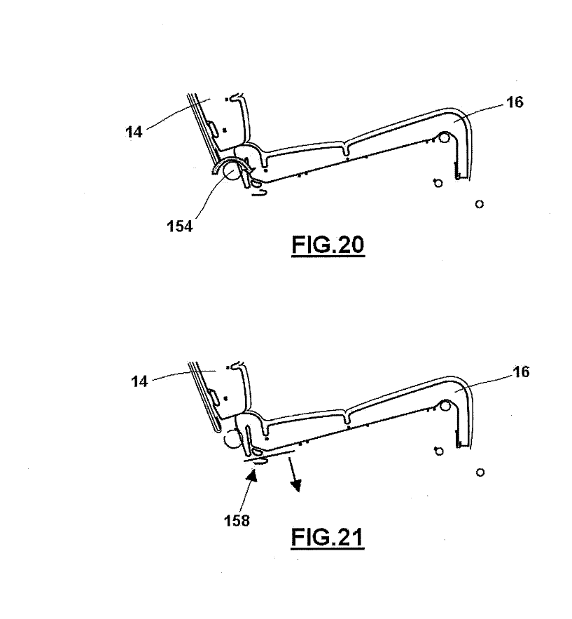

Referring now to FIGS. 17-21, seat 12 occupant detection systems 146 are shown. The seat occupant detection systems 146 regulate the engagement or disengagement of the energy storage bypass mechanism 56 depending on whether the seat 12 is occupied or unoccupied. According to one exemplary embodiment, a cable 70 can be placed across the top surface 148 of the seat 12 (e.g., seat base, seat back, etc.) and coupled to the interlock member 66, as shown in FIG. 17. Once the seat 12 is occupied, the weight of the occupant causes the cable 70 to be pulled causing the interlock member 66 to disengage from the pinion member 64 thereby preventing the recliner from disengaging. According to another exemplary embodiment, a cable 70 can be placed across the suspension surface 150 of the seat 12 (e.g., seat base wiring/frame, etc.) and coupled to the interlock member 66, as shown in FIG. 18. Once the seat 12 is occupied, the weight of the occupant would cause the cable 70 to be pulled causing the interlock member 66 to disengage from the pinion member 64 thereby preventing the recliner from disengaging. According to another exemplary embodiment, a cable 70 can be coupled to the front link 152 of the vehicle seat 12 and to the interlock member 66, as shown in FIG. 19A-19B. Once the seat 12 is occupied, the weight of the occupant would cause the cable 70 to be pulled causing the interlock member 66 to disengage from the pinion member 64 thereby preventing the recliner from disengaging. Similar techniques can be employed using a spring loaded drum 154 and cable system (as shown in FIG. 20), a cable and slot system 156, and a triggering device 158 under the vehicle seat 12 (as shown in FIG. 21).

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

It is also important to note that the construction and arrangement of the elements of the vehicle seat as shown in the preferred and other exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures and combinations. Accordingly, all such modifications are intended to be included within the scope of the present innovations. Other substitutions, modifications, changes and omissions may be made in the design, operating conditions and arrangement of the preferred and other exemplary embodiments without departing from the spirit of the present innovations.

What is claimed is:

1. A seat for use in a vehicle, the seat comprising:
a seat back pivotably coupled to a seat base by a recliner mechanism such that the seat back can be pivoted in a forward and rearward direction relative the seat base;
a track assembly coupled to the vehicle and the seat, such that the seat can be moved in the forward and rearward directions relative to the vehicle interior;
an actuator mechanism having a first actuator, a second actuator, and an energy storage device for storing energy generated from movement of the seat and selectively releasing the stored energy to assist in repositioning the seat when at least one of the first actuator and second actuator is actuated; and
wherein actuating the first actuator causes the seat to move from a first position to a second position, and wherein actuating the second actuator causes the seat to move from a first position to a third position.

2. The seat of claim 1, wherein the first position is a use position, the second position is an easy-entry position, and the third position is a fold-flat position.

3. The seat of claim 2, wherein the first actuator and the second actuator are one of a handle, lever, and push button.

4. The seat of claim 3, wherein at least one of the first actuator and the second actuator is activated mechanically.

5. The seat of claim 4, wherein at least one of the first actuator and the second actuator is activated electronically.

6. The seat of claim 5, wherein at least one of the actuator mechanism, the first actuator and the second actuator is activated remotely.

7. A seat for use in a vehicle, the seat comprising:
a seat back pivotably coupled to a seat base by a recliner mechanism such that the seat back can be pivoted in a forward and rearward direction relative the seat base;
a track assembly coupled to the vehicle and the seat, such that the seat can be moved in the forward and rearward directions relative to the vehicle interior;
an actuator mechanism having a first actuator, a second actuator, and an energy storage device for storing energy generated from movement of the seat and selectively releasing the stored energy to assist in repositioning the seat when at least one of the first actuator and second actuator is actuated;
wherein actuating the first actuator causes the seat to move from a first position to a second position, and wherein actuating the second actuator causes the seat to move from a first position to a third position; and
an energy bypass mechanism that prevents the release of stored energy in the energy storage device when the seat is occupied and enables the release of stored energy in the energy device when the seat is not occupied.

8. The seat of claim 7, wherein the first position is a use position, the second position is an easy-entry position, and the third position is a fold-flat position.

9. The seat of claim 8, wherein the first actuator and the second actuator are one of a handle, lever, and push button.

10. The seat of claim 9, wherein at least one of the first actuator and the second actuator is activated mechanically.

11. The seat of claim 10, wherein at least one of the first actuator and the second actuator is activated electronically.

12. The seat of claim 11, wherein at least one of the actuator mechanism, the first actuator and the second actuator is activated remotely.

13. The seat of claim 12, wherein the energy bypass mechanism further comprises:
a housing;
a pivot member disposed within the housing and coupled to the energy storage device and having a central aperture, wherein the pivot member is pivotably coupled to the housing and the seat, and wherein the energy storage device biases the pivot member in a predetermined direction;
a slide block member slidably disposed within the housing and having a first end and a second end, the first end having a surface for engagement with the pivot member;
a pinion member disposed within the housing and having a first end and a second end, the first end having a biasing member for coupling to the slide block member,
an interlock member disposed within the housing and having a first end and a second end, wherein the first end includes a surface for engagement with the pinion member and the second end includes a surface having a biasing member that biases the pinion member away from the slide block member; and
wherein the interlock member is in engagement with the slide block member when the seat is occupied, thereby enabling the energy stored in the energy storage device to be released upon actuation of at least one of the first actuator and the second actuator; and
wherein the interlock member is disengaged from pinion member and the pinion member is disengaged from the slide block member when the seat is occupied, thereby preventing the slide block member from being disengaged from the pivot member and thereby preventing the energy stored in the energy storage device from being released upon actuation of at least one of the first actuator and the second actuator.

14. The seat of claim 13, further comprising:
a seat occupation detection system for regulating the engagement and disengagement of the energy storage bypass mechanism.

15. The seat of claim 14, further comprising a cable having a first end coupled to the seat and a second end coupled to the interlock member; and
wherein the cable is coupled to the seat such that the weight of seat occupant causes the cable to be displaced and pull the interlock member out of engagement with the pinion member, thereby preventing the disengagement of the recliner mechanism.
